(19) United States
(12) Patent Application Publication
(10) Pub. No.: US 2021/0272131 A1
(43) Pub. Date: Sep. 2, 2021

(54) AUTOMATIC RECORDING SYSTEM

(71) Applicant: Amos Enabosi, Piscataway, NJ (US)

(72) Inventor: Amos Enabosi, Piscataway, NJ (US)

(21) Appl. No.: 17/186,563

(22) Filed: Feb. 26, 2021

Related U.S. Application Data
(60) Provisional application No. 62/983,331, filed on Feb. 28, 2020.

(51) Int. Cl. G06Q 30/00; G10L 25/51; G06F 3/16; H04N 5/76; H04N 5/232; B60Q 9/00; G06Q 50/26; G07C 5/08

(52) U.S. Cl. CPC G06Q 30/018; G10L 25/51; G06F 3/165; G07C 5/08; H04N 5/232; B60Q 9/00; G06Q 50/26; H04N 5/76

(57) ABSTRACT

An automatic recording system may capture a critical event involving a law enforcement officer. The system detects, at a companion device, an activation event. The system also activates, in response to the detection of the activation event, one or more recording devices to capture a recording comprising a critical event. The one or more recording devices are worn by a law enforcement officer. The system may record, by the one or more recording devices, the critical event. The system may detect completion of the critical event. The system may end, upon completion of the critical event, the recording of the critical event. The system may store, at the one or more recording devices, the recording. The system may deactivate, in response to the storage of the recording, the one or more recording devices. Related systems and articles of manufacture, including apparatuses and computer program products, are also disclosed.

### CROSS-REFERENCE TO RELATED APPLICATIONS

The present application claims priority to U.S. Provisional Application No. 62/983,331, filed on Feb. 28, 2020, and entitled “Automatic Recording System,” the entirety of which is incorporated by reference herein.

### TECHNICAL FIELD

The subject matter described herein relates generally to an automatic recording system for automatically activating a recording device to capture a critical event involving a law enforcement officer.

### BACKGROUND

Generally, law enforcement officers, including police officers, need to manually activate a recording device during certain events, such as during a stop, search, arrest, and/or the like. The law enforcement officers may then need to manually turn off the recording devices when cleared to do so. However, certain critical events may rise in which the law enforcement officer forgets to turn on the recording device, does not have time to turn on the recording device, and/or otherwise fails to manually turn on the recording device. Thus, the critical event may not be properly captured by the recording device. The automatic recording system described herein may be automatically activated so that the critical events may be properly captured.

### SUMMARY

Systems, methods, and articles of manufacture, including computer program products, are provided for automatically activating a recording device upon detection of an activation event, including activation of a siren, withdrawal of a weapon from a holster, and/or other events.

According to some aspects, a method includes detecting, at a companion device, an activation event. The method may also include activating, in response to the detection of the activation event, one or more recording devices to capture a recording comprising a critical event. The one or more recording devices may be worn by a user. The method may also include recording, by the one or more recording devices, the critical event. The method may also include detecting completion of the critical event. The method may also include ending, upon completion of the critical event, the recording of the critical event. The method may also include storing, at the one or more recording devices, the recording. The method may also include deactivating, in response to the storage of the recording, the one or more recording devices.

According to some aspects, a method includes detecting, at a companion device, an activation event. The method may also include activating, in response to the detection of the activation event, the one or more recording devices to capture a recording comprising the critical event. The one or more recording devices may be worn by the law enforcement officer. The method may include recording, by the one or more recording devices, the critical event. The method may include detecting completion of the critical event. The method may include ending, upon completion of the critical event, the recording of the critical event. The method may include storing, at the one or more recording devices, the recording. The method may include deactivating, in response to the storage of the recording, the one or more recording devices.

In some aspects, the critical event is one or more of an arrest, a stop, a seizer, and a search performed by the law enforcement officer.

In some aspects, the activation event comprises detection of a siren, a light, and/or an indicator, the siren, the light, and/or the indicator indicating the beginning of the critical event.

In some aspects, the indicator is from a law enforcement vehicle.

In some aspects, the activation event comprises removal of a weapon from a holster, the holster being worn by the law enforcement officer.

In some aspects, the companion device comprises a law enforcement alerting device on a vehicle.

In some aspects, the companion device comprises a holster of a weapon of the law enforcement officer.

In some aspects, the recording includes generating one or more transaction records associated with the recording, the generating including linking the one or more transaction records to the recording. In some aspects, the linking includes linking the one or more transaction records with a timestamp indicating a start time and an end time of the critical event.

In some aspects, the recording comprises at least one video, image, and audio recording.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to automatically activating recording devices for law enforcement, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts a system diagram illustrating an automatic recording system, in accordance with some example embodiments;

FIG. 2 depicts another system diagram illustrating an automatic recording system, in accordance with some example embodiments;

FIG. 3 depicts a flowchart illustrating a process for automatically recording a critical event, in accordance with some example embodiments; and

FIG. 4 depicts a block diagram illustrating a computing system, in accordance with some example embodiments.

When practical, similar reference numbers denote similar structures, features, or elements.

### DETAILED DESCRIPTION

Recording devices, such as cameras, may be used by and/or worn by law enforcement, for example, to record images, video, and/or audio of various events, such as a stop, search, arrest, interaction with another person, and/or the like. These recordings may provide useful information to a law enforcement team, such as during an audit of the events, so that the team may understand the events that occurred. Generally, law enforcement officers, including police officers, need to manually activate the recording devices before and/or during such events. The law enforcement officers may then need to manually turn off the recording devices when cleared to do so. However, certain critical events may rise in which the recording device is not turned on, and thus, the recording device does not record the events. For example, the law enforcement officer may forget to turn on the recording device, may not have time to turn on the recording device, and/or may otherwise fail to manually turn on the recording device. Thus, the critical event may not be properly captured by the recording device. Even in some circumstances in which the recording device was activated, the recording device may not be turned off at the completion of the event, resulting in wasted device resources, such as a decrease in available video storage space, a decrease in battery life of the recording device, failure to save the recorded footage, and/or the like.

As noted above, generally, law enforcement officers, including police officers, need to manually activate the recording devices before and/or during certain critical events. Some devices may require the law enforcement officers to press a button (e.g., worn on the officer's belt) to cause the recording device (e.g., worn on the officer's helmet) to begin recording. Other devices may require the law enforcement officers to use a slider (e.g., worn on the officer's chest) to cause the recording device (e.g., worn on the officer's helmet) to begin recording. However, these devices may be uncomfortable to the wearer and undesirably rely on the officer manually activating the recording devices. Additionally and/or alternatively, these devices may also undesirably rely on the officer manually deactivating the recording devices, resulting in recording a greater amount of the event than necessary or failing to record the critical event (or entirety of the critical event). As noted above, this may lead to wasted device resources.

Additionally and/or alternatively, some devices may capture recording (e.g., video) feeds that live streams the captured event to another location, such as a precinct, where other officers may review the live footage. However, this may render the recorded footage unsecure and may also result in wasted device resources. This may also undesirably require multiple officers to record and view a single event, without providing the ability to later audit the recorded footage.

The automatic recording system described herein may generate useful recordings that properly capture a critical event, such as an entirety of a critical event, a required portion of the critical event, and the like. For example, the automatic recording system may be automatically activated so that the critical events (e.g., the entirety or required portion of the critical events) are captured. In some implementations, upon detection of an activation event, the recording devices worn and/or used by law enforcement may be automatically activated to capture the critical event. Upon detecting completion of the critical event, the recording devices may automatically be deactivated and/or the recording recorded by the recording device may be stored. As an example, a sensor of the automatic recording system may detect activation of a siren, light, and/or other indicator. The sensor may then transmit a signal to the recording device, causing the recording device to be automatically activated. As another example, a sensor of the automatic recording system may detect that a weapon has been withdrawn from a law enforcement officer's holster. The sensor may then transmit a signal to the recording device, causing the recording device to be automatically activated. Accordingly, the automatic recording system described herein may desirably fully capture a critical event and/or may help to reduce wasted resources (e.g., storage, battery power, and/or the like). The automatic recording system described herein may also help enhance law enforcement concentration at a particular event, as the law enforcement officer would not need to handle activation and deactivation of the recording system.

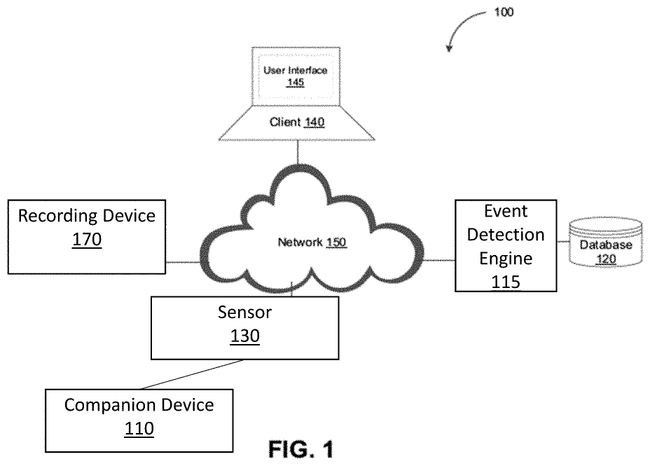

FIG. 1 depicts a system diagram illustrating an automatic recording system 100, in accordance with some example embodiments. The automatic recording system 100 may include an event detection engine 115, a sensor 130 coupled with a companion device 110, a recording device 170, and a client 140. As shown in FIG. 1, the event detection engine 115, the sensor 130, the recording device 170, and the client 140 may be communicatively coupled via a network 150. The event detection engine 115 may be coupled to or otherwise form a part of the sensor 130 and/or the recording device 170. In some embodiments, the client 140 may be coupled to or otherwise form a part of the recording device 170, the sensor 130, and/or the companion device 110. The network 150 may be any wired and/or wireless network including, for example, a public land mobile network (PLMN), a wide area network (WAN), a local area network (LAN), a virtual local area network (VLAN), the Internet, and/or the like.

The recording device 170 may include one or more, one, two, three, four, five, six, seven, eight, nine, ten, or more recording devices. The recording device 170 may be worn by a user, such as a law enforcement officer. For example, the recording device 170 may be mounted to the user's belt, chest, helmet, and/or other location. The recording device 170 may be any recording device including, for example, a video camera, a still image camera, an audio recorder, and/or the like. In some embodiments, the recording device 170 also includes a motion sensor coupled with one or more of the recording devices. Additionally and/or alternatively, the recording devices may be capable of recording images and/or video in the dark or other low-light environments. The recording device 170 may be configured to capture images, videos, and/or audio recordings of certain events, such as critical events, including a stop, search, arrest, chase, and/or the like.

Referring again to FIG. 1, the automatic recording system 100 may include sensor 130. The sensor 130 may include light sensors, motion sensors, sound sensors, and/or the like. The sensor 130 may include one or more, one, two, three, four, five, six, seven, eight, nine, ten, or more sensors. The sensor 130 may be positioned on and/or be coupled to the user (e.g., mounted to the law enforcement officer), a companion device 110, a vehicle of the user (e.g., a law enforcement vehicle), and/or the like. The sensor 130 may detect an activation event, such as for example, a siren, light, or other indicator being displayed by and/or emitted from another device, such as the vehicle, removal of a weapon from a holster, and/or the like.

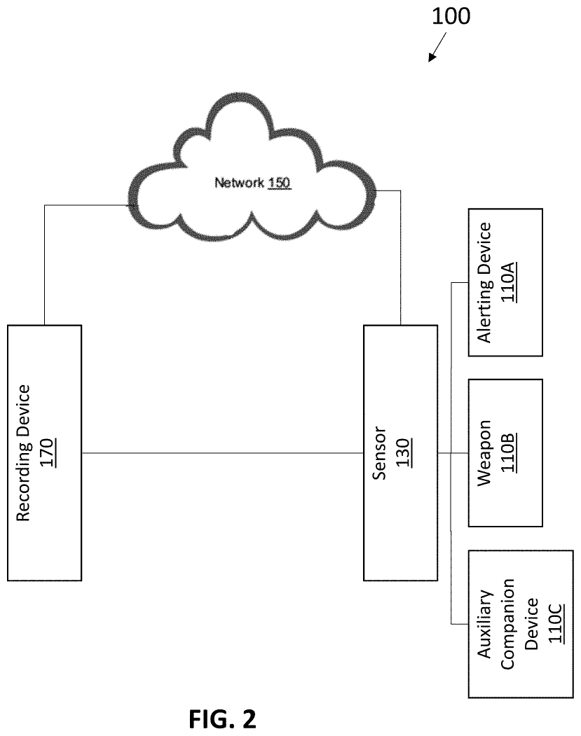

To further illustrate, FIG. 2 illustrates an example of the automatic recording system 100 including the recording device 170, the sensor 130, and the companion device 110, consistent with implementations of the current subject matter. As shown in FIG. 2, the recording device may be positioned at a location that is remote (e.g., physically remote) from the sensor 130. For example, the recording device 170 may be positioned on a chest, helmet, belt, and/or the like of the user, while the sensor 130 may be positioned on another portion of the user, such as in or on a holster of a weapon held by the user, and/or at a vehicle of the user.

In the example shown in FIG. 2, the sensor 130 may be coupled (e.g. physically and/or electrically) to one or more companion devices 110. The companion devices 110 may include an alerting device 110A (such as a siren, light, or other indicator), a weapon and/or holster 110B, and/or another auxiliary companion device 110C. The companion devices 110 may be coupled to the sensor 130 via a wired or wireless connection (e.g., via the network 150). Likewise, the sensor 130 and/or the companion devices 110 may be coupled to the recording device 170 via a wired or wireless connection (e.g., via the network 150)

The recording device 170 may capture an event, including the people involved in the event, and at least some of the surroundings. In this example, the recording device 170 may capture recordings (e.g., video, audio, and/or still images) and the event detection engine 115 may generate one or more transaction records associated with the recordings. The event detection engine 115 may transmit the recordings and/or the associated transaction records from the recording device 170 to a database 120 (as described in more detail below).

Referring again to FIG. 1, the automatic recording system 100 may include an event detection engine 115 and a database 120 coupled with the event detection engine 115. In some implementations, an activation event may occur, causing the recording device 170 to activate (e.g., turn on), begin recording (e.g., record a video, still image, audio, and/or the like), generate one or more transaction records (e.g., time stamps, person identifiers, user identifier and/or the like) corresponding to the recordings, transmit and/or store the recordings, deactivate (e.g., turn off), and/or the like. As noted above, an activation event may occur when an alerting device (e.g., a device that displays or emits a siren, light, or other indicator) is activated, which indicates that a critical event may be occurring and/or may occur within a predetermined amount of time (e.g., 1, 5, 10, 15, 30, 60 or more minutes). The siren, light, or other indicator may be displayed and/or emitted via a vehicle associated with the user (e.g., a law enforcement vehicle associated with a police officer), and/or another device associated with the user. Additionally and/or alternatively, the activation event may occur when a weapon is removed from a holster of the law enforcement officer, such as during a stop, search, arrest, chase, and/or the like. In some implementations, as noted above the sensor 130 may detect the activation of the alerting device and/or that the weapon has been removed from the holster and transmit a signal to the recording device, causing the recording device to activate and/or begin recording.

The event detection engine 115 may generate transaction records at the time the activation event is detected, at predetermined time intervals during the critical event being captured (e.g., every 30 seconds, 1 minute, 30 minutes, 1 hour, 12 hours, etc.) after an activation event has been detected, and/or continuously after the activation event has been detected, the critical event is occurring and/or the like. The transaction records may linked to a recording of the recording device 170 and be stored locally at the recording device 170. In some embodiments, the transaction records may be linked to a recording of the recording device 170 and transmitted to the database 120 to be later accessed for auditing and/or the like.

Additionally, and/or alternatively, in response to the detection of an activation event, the event detection engine 115 may trigger an alert, which may include a notification that may be provided via the user interface 145 at the client 140. For example, the notification may be provided via a short messaging service (SMS) text, an email, a webpage, an application, and/or the like. Additionally and/or alternatively, in response to the detection of the activation event, the event detection engine 115 may cause an increase in a sampling rate of one or more of the recording devices 170, record video and/or images in color, rather than in black and white, divert additional electronic and/or memory resources to the recording devices 170 and/or the like.

At least a portion of the data (e.g., the transaction records) captured and linked to a recording of the recording device 170, for example, by the event detection engine 115, the recording device 170 and/or the sensor 130, together with the corresponding recordings, may be stored at the recording device 170, and/or may be transmitted to the event detection engine 115 (or a database 120 coupled with the event detection engine 115) via the network 150. The data (e.g., the captured recordings, the transaction records, and the like) received at the event detection engine 115 may be evaluated by the event detection engine 115 in real time and/or stored at a database 120 coupled with the event detection engine 115 for auditing at a later time.

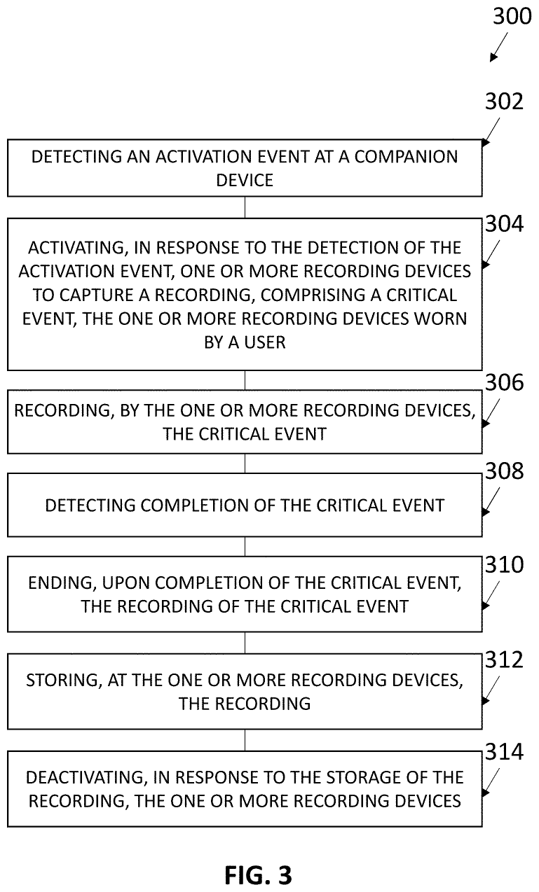

FIG. 3 depicts a flowchart illustrating a process 300 for automatically activating a recording device and recording a critical event, consistent with implementations of the current subject matter. The automatic recording system (e.g., the automatic recording system 100) may automatically activate a recording device to record an event (e.g., a critical event related to law enforcement, such as a stop, a search, a seizure, a chase, an arrest, and/or another interaction) in communication with a sensor upon detection of an activation event. The automatic recording system may increase the likelihood that the event will be recorded and/or captured. The automatic recording system may also help to decrease device and/or user resources in recording the captured event.

At 302, the event detection engine (e.g., the event detection engine 115), via one or more sensors (e.g., the sensors 130), may detect an activation event at a companion device (e.g., the companion device 110). The sensors may be coupled to the event detection engine 115 via a wired and/or wireless connection. The sensors may be light, motion, and/or other sensors that detect a light, sound, and/or other indicator. In some implementations, the sensors may additionally and/or alternatively detect when a switch is manipulated, triggering the activation event.

In some embodiments, the activation event may include activation of one or more alerting devices (e.g., a device that emits a siren, displays lights, indicators, and/or the like). The alerting devices may include a light or siren of a law enforcement vehicle. For example, the activation event may occur when the light or siren of the law enforcement vehicle emits a sound, displays a light, and/or the like. As another example, the activation event may include withdrawal of at least a portion of a weapon from a holster. For example, the law enforcement officer may withdraw their gun from its holster. In some implementations, the companion device may include the law enforcement vehicle, the holster, and/or the like. A sensor, such as the sensors described herein may detect the withdrawal of the weapon from the holster. For example, the sensor may be located on the weapon, the holster, or otherwise worn by the law officer.

At 304, the event detection engine may activate, in response to the detection of the activation event, one or more recording devices to capture a recording. The recording may include a critical event. As noted above, the critical event may include a stop, a search, an arrest, a chase, and/or another activity, such as activities performed by law enforcement officers. The recording devices may be worn and/or mounted to a user, such as a law enforcement officer. In some implementations, the recording device (e.g., the recording device 170) may include any recording device including, for example, a video camera, a still image camera, an audio recorder, and/or the like. The recording devices may be coupled to, be positioned on, or otherwise form a part of a device positioned on and/or mounted to a user such as the law enforcement officer, a vehicle, such as a vehicle of the law enforcement officer, and/or another companion device, such as the companion devices described herein. The recording devices may be configured to capture images, videos, and/or audio recordings of individuals, vehicles, and/or events taking place in association with the user (e.g., the law enforcement officer).

In some embodiments, activation of the one or more recording devices may include turning the recording devices on (e.g., supplying power to the recording devices), manipulating a switch of the recording device to supply power to the recording device, changing modes on the recording device (e.g., changing the recording device from a sleep mode to a recording mode), and/or the like. For example, upon detection of the activation event, the automatic recording system, for instance, may (e.g., automatically) supply power to the one or more recording devices, may move one or more recording devices, change the focus and/or zoom of one or more recording devices, and/or activate additional recording devices in order to capture images and/or videos of the critical event. The activation at 304 may be dynamic based on the configuration applicable to the critical event. The activation at 304 may include collecting the necessary criteria to select an appropriate configuration from a set of configurations.

At 306, the one or more recording devices may record the critical event. For example, the one or more recording devices may capture the audio, video, and/or still images of the critical event. In some implementations, one or more transaction records may be generated by the event detection engine. Generating the one or more transaction records may include linking the one or more transaction records to at least a portion of the recording. For example, each of the transaction records may include one or more transaction values corresponding to, for example, a timestamp indicating the start and/or end time of the critical event and/or activation event, a user identifier of the user (e.g., law enforcement officer), a device identifier of the recording device, the sensor, and/or the companion device, an activation event type, a critical event type, and/or the like. Accordingly, the transaction records may include data associated with one or more individuals associated with the activation event and/or the critical event. In some implementations, recording the critical event includes recording the entirety of the critical event and/or a required portion of the critical event. The required portion may include a predetermined length of time (e.g., one minute, 10 minutes, 30 minutes, 1 hour, and/or the like) and/or a predetermined length of time after the start of a critical event.

As noted above, generating the one or more transaction records may also include linking the one or more transaction records with at least a portion of the recording that includes the captured critical event. For example, the one or more transaction records may be linked to all or a portion of a recording, by storing the transaction record in association with a timestamp indicating the start and/or end time of the activation and/or critical event, a device or user identifier identifying the device or user to which the recording device that captured the recording is coupled, a recording device identifier of the recording device that captured the recording, a user identifier, and/or the like. This allows the recording to be more easily audited later on. This may also help to reduce the required device resources (e.g., power, processing time, memory, network bandwidth, and the like) to record and/or store the recordings.

At 308, the event detection engine may detect completion of the critical event. In other words, via one or more sensors, inputs, and/or the like, the event detection engine may detect that the critical event has been completed. For example, the event detection engine may detect (e.g., via the one or more sensors, inputs and/or the like) that the critical event has been completed when a siren, light, or other alerting device is deactivated or turned off, when a weapon is returned to its holster, when another input is received, and/or the like.

At 310, the event detection engine may end, upon completion of the critical event, the recording of the critical event. As noted above, the event detection engine may detect completion of the critical event. When the critical event is completed and/or when the event detection engine receives an input via the client for example, the recording may be ended or caused to be ended at the recording device.

At 312, the recording may be stored at the one or more recording devices. For example, the recording and/or the linked transaction records may be stored locally at the recording device. Additionally and/or alternatively, the generated transaction records and the recording may be transmitted to a remote database in wireless communication with the recording device to allow the recording to be viewed and/or audited at a later time.

At 314, the event detection engine may deactivate the one or more recording devices, in response to the ending of the recording, the storing of the recording and/or the detection of the completion of the critical event. For example, deactivating the one or more recording devices, may include powering down the recording devices, cutting off a supply of power to the recording devices, charging a mode of the recording devices (e.g., from a recording state to a sleep state), and/or the like. Such configurations may help to save battery life and/or improve the usable life of the recording devices. In some implementations, the deactivating includes generating an alert indicating that the critical event, the activation event, and/or the recording has been recorded, ended, stored, and/or the like. For example, the alert or notification may be provided via a short messaging service (SMS) text, an email, a webpage, an application, and/or the like. Accordingly, the automatic recording system may improve the likelihood that the entire critical event is recorded, reduce the likelihood that the critical event will not be recorded, and/or the like. This may help law enforcement ensure that certain events, such as a stop, arrest, search, or other interaction, is properly captured by the recording devices.

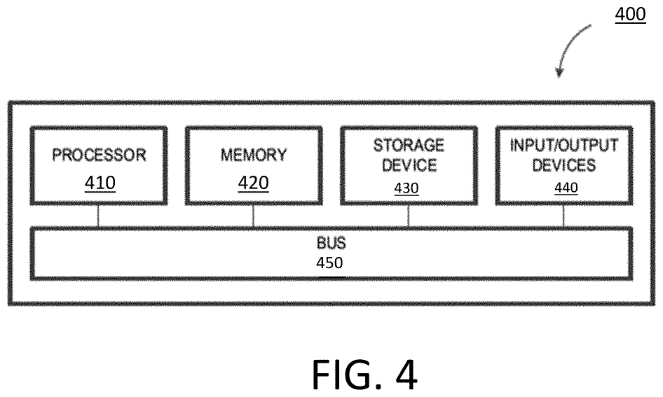

As shown in FIG. 4, the computing system 400 can include a processor 410, a memory 420, a storage device 430, and input/output devices 440. The processor 410, the memory 420, the storage device 430, and the input/output devices 440 can be interconnected via a system bus 450. The processor 410 is capable of processing instructions for execution within the computing system 400. In some example embodiments, the processor 410 can be a single-threaded processor. Alternatively, the processor 410 can be a multi-threaded processor. The processor 410 is capable of processing instructions stored in the memory 420 and/or on the storage device 430 to present graphical information for a user interface provided via the input/output device 440.

The memory 420 is a computer readable medium such as volatile or non-volatile that stores information within the computing system 400. The memory 420 can store data structures representing configuration object databases, for example. The storage device 430 is capable of providing persistent storage for the computing system 400. The storage device 430 can be a floppy disk device, a hard disk device, an optical disk device, or a tape device, or other suitable persistent storage means. The input/output device 440 provides input/output operations for the computing system 400. In some example embodiments, the input/output device 440 includes a keyboard and/or pointing device. In various embodiments, the input/output device 440 includes a display unit for displaying graphical user interfaces.

According to some example embodiments, the input/output device 440 can provide input/output operations for a network device. For example, the input/output device 440 can include Ethernet ports or other networking ports to communicate with one or more wired and/or wireless networks (e.g., a local area network (LAN), a wide area network (WAN), the Internet).

In some example embodiments, the computing system 400 can be used to execute various interactive computer software applications that can be used for organization, analysis and/or storage of data in various formats. Alternatively, the computing system 400 can be used to execute software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 440. The user interface can be generated and presented to a user by the computing system 400 (e.g., on a computer screen monitor, etc.).

Several embodiments discuss automatically activating one or more recording devices in relation to law enforcement. These features may be used in other contexts, such as sports, travel, and/or other interactions in which the recording device may be automatically activated for recording an event.

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

As used herein a “user interface” (also referred to as an interactive user interface, a graphical user interface or a UI) may refer to a network based interface including data fields and/or other control elements for receiving input signals or providing electronic information and/or for providing information to the user in response to any received input signals. Control elements may include dials, buttons, icons, selectable areas, or other perceivable indicia presented via the UI that, when interacted with (e.g., clicked, touched, selected, etc.), initiates an exchange of data for the device presenting the UI. A UI may be implemented in whole or in part using technologies such as hyper-text mark-up language (HTML), FLASH™, JAVA™, .NET™, web services, or rich site summary (RSS). In some embodiments, a UI may be included in a stand-alone client (for example, thick client, fat client) configured to communicate (e.g., send or receive data) in accordance with one or more of the aspects described. The communication may be to or from a medical device or server in communication therewith.

As used herein, the terms “determine” or “determining” encompass a wide variety of actions. For example, “determining” may include calculating, computing, processing, deriving, generating, obtaining, looking up (e.g., looking up in a table, a database or another data structure), ascertaining and the like via a hardware element without user intervention. Also, “determining” may include receiving (e.g., receiving information), accessing (e.g., accessing data in a memory) and the like via a hardware element without user intervention. “Determining” may include resolving, selecting, choosing, establishing, and the like via a hardware element without user intervention.

As used herein, the terms “provide” or “providing” encompass a wide variety of actions. For example, “providing” may include storing a value in a location of a storage device for subsequent retrieval, transmitting a value directly to the recipient via at least one wired or wireless communication medium, transmitting or storing a reference to a value, and the like. “Providing” may also include encoding, decoding, encrypting, decrypting, validating, verifying, and the like via a hardware element.

As used herein, the term “message” encompasses a wide variety of formats for communicating (e.g., transmitting or receiving) information. A message may include a machine readable aggregation of information such as an XML document, fixed field message, comma separated message, or the like. A message may, in some embodiments, include a signal utilized to transmit one or more representations of the information. While recited in the singular, it will be understood that a message may be composed, transmitted, stored, received, etc. in multiple parts.

As user herein, the terms “correspond” or “corresponding” encompasses a structural, functional, quantitative and/or qualitative correlation or relationship between two or more objects, data sets, information and/or the like, preferably where the correspondence or relationship may be used to translate one or more of the two or more objects, data sets, information and/or the like so to appear to be the same or equal. Correspondence may be assessed using one or more of a threshold, a value range, fuzzy logic, pattern matching, a machine learning assessment model, or combinations thereof.

In any embodiment, data generated or detected can be forwarded to a “remote” device or location, where “remote,” means a location or device other than the location or device at which the program is executed. For example, a remote location could be another location (e.g., office, lab, etc.) in the same city, another location in a different city, another location in a different state, another location in a different country, etc. As such, when one item is indicated as being “remote” from another, what is meant is that the two items can be in the same room but separated, or at least in different rooms or different buildings, and can be at least one mile, ten miles, or at least one hundred miles apart. “Communicating” information references transmitting the data representing that information as electrical signals over a suitable communication channel (e.g., a private or public network). “Forwarding” an item refers to any means of getting that item from one location to the next, whether by physically transporting that item or otherwise (where that is possible) and includes, at least in the case of data, physically transporting a medium carrying the data or communicating the data. Examples of communicating media include radio or infra-red transmission channels as well as a network connection to another computer or networked device, and the internet or including email transmissions and information recorded on websites and the like.

As used herein, the terms “control” or “controlling” encompass a wide variety of actions. For example, “controlling” a device may include transmitting one or more messages to adjust an operational state or functional element of the device. The message may include specific instructions to be executed by a processor of the device to manifest the change. The “controlling” may include storing a value in a location of a storage device for subsequent retrieval by the device to be controlled, transmitting a value directly to the device to be controlled via at least one wired or wireless communication medium, transmitting or storing a reference to a value, and the like. For example, a control message may include a value to adjust a level of power from a power source of the controlled device. As another example, a control message may activate or deactivate a structural element of the controlled device such as a light, audio playback, a motor, a lock, a pump, a display, a servo, or other component of a device described herein. “Controlling” may include indirect control of the device by adjusting a configuration value used by the controlled device. For example, the control message may include a threshold value for a device characteristic (e.g., temperature, rate, frequency, etc.). The threshold value may be stored in a memory location and referred to by the controlled device during operation.

The subject matter described herein can be embodied in systems, apparatus, methods, and/or articles depending on the desired configuration. The embodiments set forth in the foregoing description do not represent all embodiments consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the embodiments described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other embodiments may be within the scope of the following claims.

What is claimed is:

1. A system for capturing a critical event involving a law enforcement officer, comprising:
one or more recording devices;
at least one data processor; and
at least one memory storing instructions which, when executed by the at least one data processor, result in operations comprising:
detecting, at a companion device, an activation event;
activating, in response to the detection of the activation event, the one or more recording devices to capture a recording comprising the critical event, the one or more recording devices worn by the law enforcement officer;
recording, by the one or more recording devices, the critical event;
detecting completion of the critical event;
ending, upon completion of the critical event, the recording of the critical event;
storing, at the one or more recording devices, the recording; and
deactivating, in response to the storage of the recording, the one or more recording devices.

2. The system of claim 1, wherein the critical event is one or more of an arrest, a stop, a seizer, and a search performed by the law enforcement officer.

3. The system of claim 1, wherein the activation event comprises detection of a siren, a light, and/or an indicator, the siren, the light, and/or the indicator indicating the beginning of the critical event.

4. The system of claim 3, wherein the indicator is from a law enforcement vehicle.

5. The system of claim 1, wherein the activation event comprises removal of a weapon from a holster, the holster being worn by the law enforcement officer.

6. The system of claim 1, wherein the companion device comprises a law enforcement alerting device on a vehicle.

7. The system of claim 1, wherein the companion device comprises a holster of a weapon of the law enforcement officer.

8. The system of claim 1, wherein the recording comprises generating one or more transaction records associated with the recording, the generating comprising linking the one or more transaction records to the recording.

9. The system of claim 8, wherein the linking comprises linking the one or more transaction records with a timestamp indicating a start time and an end time of the critical event.

10. The system of claim 1, wherein the recording comprises at least one video, image, and audio recording.

11. A method for capturing a critical event involving a law enforcement officer, comprising:
detecting, at a companion device, an activation event;
activating, in response to the detection of the activation event, one or more recording devices to capture a recording comprising the critical event, the one or more recording devices worn by the law enforcement officer;
recording, by the one or more recording devices, the critical event;
detecting completion of the critical event;
ending, upon completion of the critical event, the recording of the critical event;
storing, at the one or more recording devices, the recording; and
deactivating, in response to the storage of the recording, the one or more recording devices.

12. The method of claim 11, wherein the critical event is one or more of an arrest, a stop, a seizer, and a search performed by the law enforcement officer.

13. The method of claim 11, wherein the activation event comprises detection of a siren, a light, and/or an indicator, the siren, the light, and/or the indicator indicating the beginning of the critical event.

14. The method of claim 11, wherein the indicator is from a law enforcement vehicle.

15. The method of claim 11, wherein the activation event comprises removal of a weapon from a holster, the holster being worn by the law enforcement officer.

16. The method of claim 11, wherein the companion device comprises a law enforcement alerting device on a vehicle.

17. The method of claim 11, wherein the companion device comprises a holster of a weapon of the law enforcement officer.

18. The method of claim 11, wherein the recording comprises generating one or more transaction records associated with the recording, the generating comprising linking the one or more transaction records to the recording.

19. The method of claim 11, wherein the recording comprises at least one video, image, and audio recording.

20. A non-transitory computer-readable storage medium including program code, which when executed by at least one data processor, cause operations comprising:
detecting, at a companion device, an activation event;
activating, in response to the detection of the activation event, one or more recording devices to capture a recording comprising a critical event, the one or more recording devices worn by a law enforcement officer;
recording, by the one or more recording devices, the critical event;
detecting completion of the critical event;
ending, upon completion of the critical event, the recording of the critical event;
storing, at the one or more recording devices, the recording; and
deactivating, in response to the storage of the recording, the one or more recording devices.
